(19) United States
(12) Patent Application Publication
(10) Pub. No.: US 2020/0073405 A1
(43) Pub. Date: Mar. 5, 2020

(54) VEHICLE NAVIGATION AND CONTROL

(71) Applicant: Ford Global Technologies, LLC, Dearborn, MI (US)

(72) Inventors: Lu Xu, Dearborn, MI (US); Linjun Zhang, Canton, MI (US); Qi Chen, Canton, MI (US); Helen Elizabeth Kourous-Harrigan, Monroe, MI (US); Jeffrey Thomas Remillard, Ypsilanti, MI (US); Codrin Cionca, Ann Arbor, MI (US)

(73) Assignee: Ford Global Technologies, LLC, Dearborn, MI (US)

(21) Appl. No.: 16/121,675

(22) Filed: Sep. 5, 2018

(51) Int. Cl. G05D 1/02; G05D 1/00; G08G 1/0967; B60W 30/18

(52) U.S. Cl. CPC G05D 1/0276; G05D 1/0088; G08G 1/096725; G08G 1/096783; B60W 30/18; G05D 2201/0213; B60W 2420/42; B60W 2550/147; B60W 2550/143; B60W 2550/142; B60W 2420/52; B60W 2420/54; B60W 2550/148

(57) ABSTRACT

A map is received in a vehicle. The map is generated from infrastructure node sensor data specifying a location and a measurement of a physical value controlling vehicle operation at the location. A maneuver for the vehicle is determined based in part on the physical value and the location.

### BACKGROUND

Vehicles often rely on sensor data for operation. For example, sensors such as cameras, radar, lidar, ultrasound, etc., can provide data for identifying objects, e.g., road signs, other vehicles, pedestrians, etc., and road conditions, e.g., ice, snow, cracks, potholes, bumps, etc. However, vehicle sensors cannot provide data concerning phenomena outside their fields of view and/or may provide inaccurate and/or incomplete data under certain conditions, if not operating properly, etc.

### BRIEF DESCRIPTION OF THE DRAWINGS

FIG. 1 is a diagram illustrating an example vehicle navigation and control system.

FIG. 2 illustrates an exemplary road scene.

FIG. 3 is a flowchart of an exemplary process for generating and providing road condition map data in an infrastructure node.

FIG. 4 is a flowchart of an exemplary process for navigating a vehicle according to data provided by an infrastructure node.

### DETAILED DESCRIPTION

A method comprises receiving, in a vehicle, a map generated from infrastructure node sensor data specifying a location and a measurement of a physical value controlling vehicle operation at the location; and determining a maneuver for the vehicle based in part on the physical value and the location.

The physical value controlling vehicle operation can be one of a tire corner coefficient, an acceleration, a steering angle, a maximum safe speed, and a stop distance.

The vehicle can be operated based on the maneuver. The maneuver can include a path polynomial, the method further comprising using the physical value as input to determining the path polynomial.

The method can further comprise transmitting, from the vehicle, the physical value limiting vehicle operation to a second vehicle.

The method can further comprise adjusting, in the vehicle computer, the physical value limiting vehicle operation.

The map can further specify a second location and a second measurement of a physical value controlling vehicle operation at the second location.

The map can further specify a measurement of a second physical value limiting vehicle operation at the location.

The physical value can describe one or more of a road bank, a road grade, a road friction, a pothole, a bump, and a debris object.

The node sensor data can include one or more of LIDAR, RADAR, ultrasound, and camera image data.

A computer comprises a processor and a memory, the memory storing instructions executable by the processor to: receive, in a vehicle, a map generated from infrastructure node sensor data specifying a location and a measurement of a physical value controlling vehicle operation at the location; and determine a maneuver for the vehicle based in part on the physical value and the location.

The physical value controlling vehicle operation can be one of a tire corner coefficient, an acceleration, a steering angle, a maximum safe speed, and a stop distance.

The vehicle can be operated based on the maneuver. The maneuver can include a path polynomial, the method further comprising using the physical value as input to determining the path polynomial.

The instructions can further comprise to transmit, from the vehicle, the physical value limiting vehicle operation to a second vehicle.

The instructions can further comprise to adjust, in the vehicle computer, the physical value limiting vehicle operation.

The map can further specify a second location and a second measurement of a physical value controlling vehicle operation at the second location.

The map can further specify a measurement of a second physical value limiting vehicle operation at the location.

The physical value can describe one or more of a road bank, a road grade, a road friction, a pothole, a bump, and a debris object.

The node sensor data can include one or more of LIDAR, RADAR, ultrasound, and camera image data.

An infrastructure node can be equipped with sensors and computing devices to obtain data about a roadway in an area proximate to the infrastructure node. For example, the data can include data about a road surface, such as presence of potholes, bumps, debris, slippery areas, a road bank, a road grade, etc. The node can include the data on a map or the like specifying locations in the area proximate to the infrastructure node. For each specified location, the map can further specify one or more physical values, e.g., representing road surface conditions. A vehicle traveling in the area proximate to the infrastructure node can receive the map, and can include data from the map as input to a vehicle computer's determination of a planned path for the vehicle. That is, the vehicle computer can use a physical value from the road condition map to plan or modify a vehicle path or maneuver.

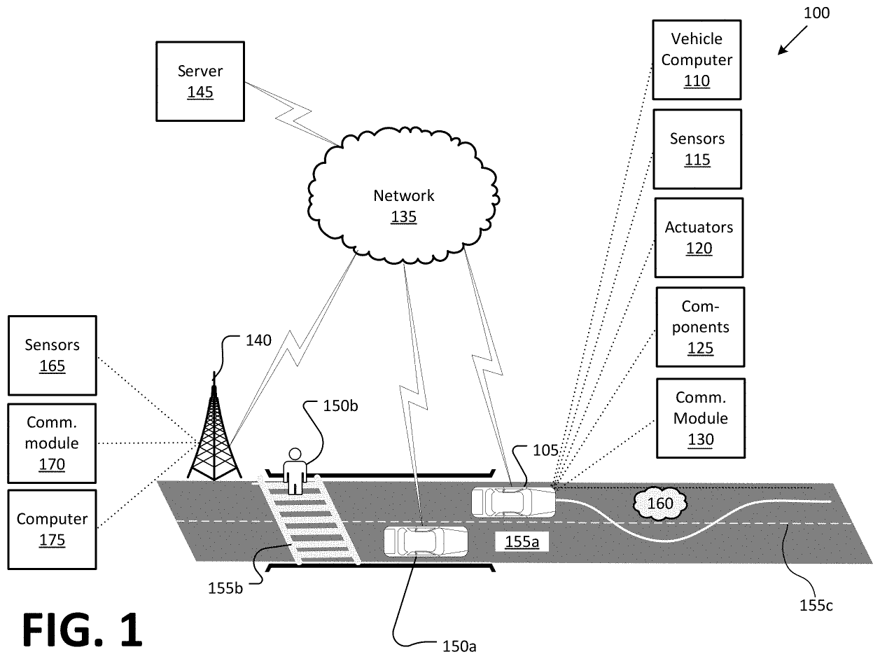

FIG. 1 is a block diagram of an example vehicle control system 100. The system 100 includes a vehicle 105, which is a land vehicle such as a car, truck, etc. The vehicle 105 includes a vehicle computer 110, vehicle sensors 115, actuators 120 to actuate various vehicle components 125, and a vehicle communications module 130. Via a network 135, the communications module 130 allows the vehicle computer 110 to communicate with one or more data collection or infrastructure nodes 140, a central server 145 and/or a second vehicle 150a.

The vehicle computer 110 includes a processor and a memory. The memory includes one or more forms of computer-readable media, and stores instructions executable by the vehicle computer 110 for performing various operations, including as disclosed herein.

The vehicle computer 110 may operate a vehicle 105 in an autonomous, a semi-autonomous mode, or a non-autonomous (or manual) mode. For purposes of this disclosure, an autonomous mode is defined as one in which each of vehicle 105 propulsion, braking, and steering are controlled by the vehicle computer 110; in a semi-autonomous mode the vehicle computer 110 controls one or two of vehicles 105 propulsion, braking, and steering; in a non-autonomous mode a human operator controls each of vehicle 105 propulsion, braking, and steering.

The vehicle computer 110 may include programming to operate one or more of vehicle 105 brakes, propulsion (e.g., control of acceleration in the vehicle by controlling one or more of an internal combustion engine, electric motor, hybrid engine, etc.), steering, climate control, interior and/or exterior lights, etc., as well as to determine whether and when the vehicle computer 110, as opposed to a human operator, is to control such operations. Additionally, the vehicle computer 110 may be programmed to determine whether and when a human operator is to control such operations.

The vehicle computer 110 may include or be communicatively coupled to, e.g., via the vehicle 105 communications module 130 as described further below, more than one processor, e.g., included in electronic controller units (ECUs) or the like included in the vehicle 105 for monitoring and/or controlling various vehicle components 125, e.g., a powertrain controller, a brake controller, a steering controller, etc. Further, the vehicle computer 110 may communicate, via the vehicle 105 communications module 130, with a navigation system that uses the Global Position System (GPS). As an example, the vehicle computer 110 may request and receive location data of the vehicle 105. The location data may be in a known form, e.g., geo-coordinates (latitudinal and longitudinal coordinates)

The vehicle computer 110 is generally arranged for communications on the vehicle 105 communications module 130 and also with a vehicle 105 internal wired and/or wireless network, e.g., a bus or the like in the vehicle 105 such as a controller area network (CAN) or the like, and/or other wired and/or wireless mechanisms.

Via the vehicle 105 communications network, the vehicle computer 110 may transmit messages to various devices in the vehicle 105 and/or receive messages from the various devices, e.g., vehicle sensors 115, actuators 120, vehicle components 125, a human machine interface (HMI), etc. Alternatively or additionally, in cases where the vehicle computer 110 actually comprises a plurality of devices, the vehicle 105 communications network may be used for communications between devices represented as the vehicle computer 110 in this disclosure. Further, as mentioned below, various controllers and/or vehicle sensors 115 may provide data to the vehicle computer 110.

Vehicle sensors 115 may include a variety of devices such as are known to provide data to the vehicle computer 110. For example, the vehicle sensors 115 may include Light Detection And Ranging (LIDAR) sensor(s) 115, etc., disposed on a top of the vehicle 105, behind a vehicle 105 front windshield, around the vehicle 105, etc., that provide relative locations, sizes, and shapes of objects 150, 155, 160 surrounding the vehicle 105. As another example, one or more radar sensors 115 fixed to vehicle 105 bumpers may provide data to provide and range velocity of the objects 150, 155, 160 (such as second vehicles 150a), etc., relative to the location of the vehicle 105. The vehicle sensors 115 may further alternatively or additionally, for example, include camera sensor(s) 115, e.g. front view, side view, etc., providing images from an area surrounding the vehicle 105.

The vehicle 105 actuators 120 are implemented via circuits, chips, motors, or other electronic and or mechanical components that can actuate various vehicle subsystems in accordance with appropriate control signals as is known. The actuators 120 may be used to control components 125, including braking, acceleration, and steering of a vehicle 105.

In the context of the present disclosure, a vehicle component 125 is one or more hardware components adapted to perform a mechanical or electro-mechanical function or operation—such as moving the vehicle 105, slowing or stopping the vehicle 105, steering the vehicle 105, etc. Non-limiting examples of components 125 include a propulsion component (that includes, e.g., an internal combustion engine and/or an electric motor, etc.), a transmission component, a steering component (e.g., that may include one or more of a steering wheel, a steering rack, etc.), a brake component (as described below), a park assist component, an adaptive cruise control component, an adaptive steering component, a movable seat, etc.

In addition, the vehicle computer 110 may be configured for communicating via a vehicle-to-vehicle communication module or interface 130 with devices outside of the vehicle 105, e.g., through a vehicle-to-vehicle (V2V) or vehicle-to-infrastructure (V2X) wireless communications to another vehicle, to an infrastructure node 140 (typically via direct radio frequency communications) and/or (typically via the network 135) a remote server 145. The module 130 could include one or more mechanisms by which the vehicle computer 110 may communicate, including any desired combination of wireless (e.g., cellular, wireless, satellite, microwave and radio frequency) communication mechanisms and any desired network topology (or topologies when a plurality of communication mechanisms are utilized). Exemplary communications provided via the module 130 include cellular, Bluetooth®, IEEE 802.11, dedicated short range communications (DSRC), and/or wide area networks (WAN), including the Internet, providing data communication services.

The network 135 includes one or more mechanisms by which a vehicle computer 110 may communicate with an infrastructure node 140, a central server 145, and/or a second vehicle 150a. Accordingly, the network 135 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth, Bluetooth Low Energy (BLE), IEEE 802.11, vehicle-to-vehicle (V2V) such as Dedicated Short Range Communications (DSRC), etc.), local area networks (LAN) and/or wide area networks (WAN), including the Internet, providing data communication services.

An infrastructure node 140 includes a physical structure such as a tower or other support structure (e.g., a pole, a box mountable to a bridge support, cell phone tower, road sign support, etc.) on which infrastructure sensors 165, as well as an infrastructure communications module 170 and computer 175 can be mounted, stored, and/or contained, and powered, etc. One infrastructure node 140 is shown in FIG. 1 for ease of illustration, but the system 100 could and likely would include tens, hundreds, or thousands of nodes 140. The infrastructure node 140 is typically stationary, i.e., fixed to and not able to move from a specific geographic location. The infrastructure sensors 165 may include one or more sensors such as described above for the vehicle 105 sensors 115, e.g., lidar, radar, cameras, ultrasonic sensors, etc. The infrastructure sensors 165 are fixed or stationary. That is, each sensor 165 is mounted to the infrastructure node so as to have a substantially unmoving and unchanging field of view. An area included on a road surface map provided by an infrastructure node 140, i.e., the area referred to as the area “proximate” to the node 140, is typically defined by an area within a field of view of one or more node sensors 165.

Sensors 165 thus provide fields of view in contrast to vehicle 105 sensors 115 in a number of advantageous respects. First, because sensors 165 have a substantially constant or fixed field of view, determinations of vehicle 105 and object 150, 155 locations can be accomplished with fewer and simpler processing resources than if movement of the sensors 165 also had to be accounted for. Further, the sensors 165 include an external perspective of the vehicle 105 and can sometimes detect features and characteristics of objects 150, 155, 160 not in the vehicle 105 sensors 115 field(s) of view and/or can provide more accurate detection, e.g., with respect to vehicle 105 location and/or movement with respect to other objects 150, 155. Moreover, sensors 165 can obtain data about the area proximate to the node 140 over an extended period of time than vehicle sensors 115, e.g., node sensors 165 may obtain data about an area of road 155a surface over minutes or longer, whereas a vehicle 105 may be travelling over the road 155a surface at a speed which affords perhaps a few seconds or less for sensors 115 to obtain data to determine a road 155a surface condition. Yet further, sensors 165 can communicate with the node 140 computer 175 via a wired connection, whereas vehicles 105 typically can communicate with nodes 140 and/or a server 145 only wirelessly, or only at very limited times when a wired connection is available. Wired communications are more reliable and can be faster than wireless communications such as vehicle-to-infrastructure communications or the like.

The communications module 170 and computer 175 typically have features in common with the vehicle communications module 130 and vehicle computer 110, and therefore will not be described further to avoid redundancy. Although not shown for ease of illustration, the infrastructure node 140 also includes a power source such as a battery, solar power cells, and/or a connection to a power grid.

An infrastructure node 140 can be provided to monitor one or more objects 150, 155, 160. An “object”, in the context of this disclosure, is a physical, i.e., material, structure detected by a vehicle sensor 115 and/or sensor 165. An object may be a “mobile” object 150, an infrastructure object 155, or a physical feature 160. A physical feature 160 is a physical attribute or condition of a location or area within the area proximate to an infrastructure node 140, including an attribute or condition of an infrastructure object 155, such as a surface condition of a road 155a.

A “mobile” object 150 is an object that is capable of moving, even though the mobile object 150 may or not be actually moving at any given time. The mobile object 150 is generally proximate to the node 140 for only a relatively brief period of time, e.g., at most two to three minutes. (In the present context, “proximate” to the node 140 means that the object 150 is within a field of view of one or more node 140 sensors 165.) The “mobile” object 150 is so designated for convenience to distinguish from infrastructure objects 155 and physical features 160, each discussed below. Example mobile objects 150 include a vehicle 150a (and/or, as should be readily apparent, the vehicle 105 can qualify as an object 150, hence the vehicle 105 may also be referred as an object 150), an animal (e.g., human) object 150b, a bicycle, etc. An infrastructure object 155 is an object that, typically by design, is fixed and/or remains stationary with respect to the node 140. For example, infrastructure objects 155 can include a road 155a, a crosswalk 155b, a road marking 155c, etc. Infrastructure objects 155 often are provided to govern or guide pedestrian and/or vehicular traffic, e.g., a crosswalk 155b regulates the passage of pedestrians and/vehicles 105, 150a at various locations, e.g., on a road 155a.

A physical feature 160 can lead to a redirection of a vehicle traveling on the road 155a (e.g., a pothole 160), and or modification of a planned path or trajectory of a vehicle 105, e.g., a slippery condition of a road 155a can lead to modifying a path or maneuver (e.g., modifying a speed and/or steering angle) of a vehicle 105. The physical feature 160 may be stationary or mobile. As an example, a piece of debris such as a rock may be stationary and remain in a specific location. As another example, the rock may be mobile and roll along or across the road 155a. As another example, a pothole 160 may be stationary and remain in a specific location until the pothole 160 is repaired. However, a pothole 160 may be “mobile” as the pothole 160 may grow in size. Example physical features 160 include potholes 160, fallen trees, rocks and/or other debris, slippery conditions, road grade, road bank, a material covering a road 155a surface, e.g., asphalt or gravel, etc.

The node 140 can monitor objects 150, 155, 160, i.e., the node computer 175 can receive and analyze data from sensors 165 substantially continuously, periodically, and/or when instructed by a server 145, etc. Further, conventional object classification or identification techniques can be used, e.g., in the computer 175 based on lidar sensor 165, camera sensor 165, etc., data, to identify a type of object, e.g., vehicle, person, rock, pothole, bicycle, motorcycle, etc.

The server 145 can be a conventional computing device, i.e., including one or more processors and one or more memories, programmed to provide operations such as disclosed herein. Further, the server 145 can be accessed via the network 135, e.g., the Internet or some other wide area network.

The infrastructure node 140 computer 175 can include a memory or other storage with map data describing an area (e.g., within a predetermined radius such as 100 meters, 300 meters, etc.) around the node 140. For example, such map data could be received and/or periodically updated from a central server 145, by a technician servicing the node 140, etc. Map data typically includes geo-coordinates defining fixed or stationary objects 155, e.g., a road 155a, a crosswalk 155b, a road marking 155c, as well as of physical features 160 such as a slippery location, a location with a specified road bank, a location with a pothole, etc.

Further, the computer 175 can receive various data from the node 140 sensors 165 as well as, e.g., via V2X communications, from vehicle 105 sensors 115. Image data is digital image data, e.g., comprising pixels with intensity and color values, can be acquired by camera sensors 115, 165. LIDAR data typically includes conventional LIDAR point cloud data acquired by lidar sensors 115, 165, i.e., including data describing points in three dimensions, that is, each point representing a location of a surface of an object 150, 155, 160.

Various techniques such as are known may be used to interpret sensors 115, 165 data. For example, camera and/or LIDAR image data can be provided to a classifier that comprises programming to utilize one or more conventional image classification techniques. For example, the classifier can use a machine learning technique in which data known to represent various objects 150, 155, 160, is provided to a machine learning program for training the classifier. Once trained, the classifier can accept as input an image and then provide as output, for each of one or more respective regions of interest in the image, an indication of one or more objects 150, 160 or an indication that no object 150, 160 is present in the respective region of interest. Further, a coordinate system (e.g., polar or cartesian) applied to the area proximate to a node 140 can be applied to specify locations and/or areas (e.g., according to the node 140 coordinate system, translated to global latitude and longitude geo-coordinates, etc.) of objects 150, 155, 160 identified from sensor 165 data. Yet further, a node computer 175 could employ various techniques for fusing data from different sensors 165 and/or types of sensors 165, e.g., LIDAR, RADAR, and/or optical camera data.

A road condition map typically includes one or more sets of geographic points or areas, the road condition further specifying, for respective locations, typically on a road 155a surface, one or more physical values pertaining to one or more respective physical features 160. Each physical feature 160 location is specified according to one or more pairs of coordinates according to a coordinate system such as described above, i.e., one pair of geo-coordinates specifies a point, two pairs of geo-coordinates specifies a line, and three pairs of geo-coordinates specifies an area. In addition to a specified location or area, each physical feature can include a type tag and a data value, i.e., a road condition map can comprise records, wherein each record includes a set of geo-coordinates (i.e., one or more coordinate pairs), a feature 160 type or description, and a feature 160 data value. A road condition map data value about a physical feature 160 is sometimes referred to as a “physical value” because it describes the physical feature 160. Table 1 below provides non-limiting examples of feature 160 descriptions and data values that could be included in a road condition map to be provided by a node 140 to one or more vehicles 105, the physical values then being available to a vehicle computer 110 to plan a vehicle path and/or maneuver.

TABLE 1

| Feature type | Data value(s) |
|---|---|
| Pothole | Depth (e.g., in millimeters, centimeters, etc.) and/or area (e.g., specified by a |
| | length and width, a radius about a specified location point, etc.) |
| Debris | Volume (i.e., volume of an object on a road 155a surface), e.g., in cubic |
| | meters. |
| Road bank | Bank of a road, e.g., in degrees, i.e., angle to the horizon (i.e., angle from |
| | horizontal) of a line across a road 155a perpendicular to a road 155a direction |
| | or travel |
| Road grade | Grade of a road, e.g., in degrees, i.e., angle to the horizon (i.e., angle from |
| | horizontal) of a line along a road 155a direction or travel |
| Road friction | Coefficient of friction for a road 155a surface at the specified location or area. |

A vehicle computer 110 can include features 160 included in a node 140 road condition map in determining control settings for operating the vehicle 105, e.g., in determining a path polynomial and/or other path location and/or trajectory determinations. A path polynomial is a mathematical representation of real world 3D location and motion including rates of change of lateral and longitudinal accelerations, for example. The vehicle computer 110 can determine a path polynomial that permits the vehicle to travel from an origin to a destination, based on predicted locations, a speed and a direction for the vehicle 105. The vehicle computer 110 can further determine the path polynomial based on vehicle operational parameters, i.e., values for physical features 160 that can be used to control or limit vehicle 105 operation, i.e., to specify vehicle 105 control settings such as (again, to name one example) longitudinal speed, etc. For example, a vehicle 105 operational parameter may specify a vehicle 105 stopping distance on dry pavement for various speeds, and may further specify respective stopping distances for the vehicle 105 for various speeds and/or coefficients of friction representing slippery pavement. To take another example, an operational parameter may specify safe or target speeds for respective expected vertical displacements to be experienced by a vehicle 105, e.g., due to physical features 160 such as potholes or speed bumps.

Control settings specify target values for operation of one or more vehicle components, i.e., a control setting is used to determine commands to be provided to one or more vehicle components to achieve the control setting, e.g., a longitudinal speed control setting is used to determine an engine speed to obtain a wheel speed. An operational parameter, as explained above, is a physical condition in the vehicle 105 or its environment that affects determination of one or more control settings, e.g., that can be used in determining a path polynomial. Example control settings and operational parameters are provided below in Tables 1 and 2, respectively.

The computer 110 can then determine a polynomial function of degree three or less in segments called splines, wherein the segments are constrained to fit smoothly together by constraints on first derivatives to represent predicted successive locations of the vehicle 105. Constraints on a path polynomial in real world 3D coordinates include upper limits on distance from desired trajectory, upper and lower limits on lateral and longitudinal accelerations and upper limits on rates of change of lateral and longitudinal accelerations (jerk) required to operate the vehicle 105 along the path polynomial. A path polynomial can be constrained to stay in a roadway and avoid objects 150, 160 while moving toward a destination by constraining the path polynomial to a free space region.

The vehicle computer 110 can determine a path polynomial and/or vehicle 105 maneuvers (e.g., adjustments to steering, speed, etc. that do not substantially change a vehicle 105 path) based on vehicle operational parameters such as tire corner coefficients, etc. (some of which can be the physical values provided on a road condition map from a node 140), and current vehicle control settings such as a longitudinal speed. Such values can be obtained from a CAN bus or the like in the vehicle 105. Advantageously, the vehicle computer 110 may alternatively or additionally obtain one or more vehicle operational parameters from the road condition map.

The path polynomial based on the road condition map permits the vehicle 105 to travel to a destination while avoiding collision or near-collision with objects 150, 160 by estimating free space regions and non-free space regions included in the road condition map. Free space regions are regions of the road condition map in which the vehicle 105 can be predicted to travel unimpeded on a roadway surface. Non-free space regions included in the road condition map can include non-roadway regions and regions surrounding objects, both fixed objects 160 such as rocks and potholes, and mobile objects 150 such as a second vehicle 150a and a human 150b.

The vehicle computer 110 can be programmed to substantially continuously update the path polynomial based on the operational parameters (received from one of the vehicle communications module 130 and the road condition map) and apply the path polynomial to an algorithm (1), shown below, to determine vehicle control settings such as a rate of change of lateral velocity \dot{V}, a rate of change of yaw rate \dot{ω}_{y}, a rate of change of heading direction \dot{Ø}_{y}, and a rate of change of lateral offset ė. The vehicle computer 110 may be further programmed to determine a longitudinal velocity (speed) U, based on the operational parameters. Equation (1) below provides a partial example, i.e., for illustrative purposes, of determining control settings (the vector on the left-hand side) based on current control settings and operational parameters.

$$[ \begin{matrix}\dot{V} \\ {\dot{ω}}_{y} \\ {\dot{∅}}_{y} \\ \dot{e}\end{matrix} ] = [ \begin{matrix}- \frac{{C}_{{α}_{f}} + {C}_{{α}_{r}}}{mU} & \frac{{bC}_{{α}_{r}} - {aC}_{{α}_{f}}}{mU} - U & 0 & 0 \\ \frac{{bC}_{{α}_{r}} - {aC}_{{α}_{f}}}{{J}_{y} U} & - \frac{{a}^{2} {C}_{{α}_{f}} + {b}^{2} {C}_{{α}_{r}}}{{J}_{y} U} & 0 & 0 \\ 0 & 1 & 0 & 0 \\ 1 & 0 & U & 0\end{matrix} ] [ \begin{matrix}V \\ {ω}_{y} \\ {∅}_{y} \\ e\end{matrix} ] + [ \begin{matrix}\frac{{C}_{{α}_{f}}}{m} \\ \frac{{aC}_{{α}_{f}}}{{J}_{y}} \\ 0 \\ 0\end{matrix} ] δ \qquad ( 1 )$$

Table 1 below provides an explanation of the control settings, and Table 2 provides an explanation of the operational parameters, in Equation (1).

TABLE 1

| Control Setting | Explanation |
|---|---|
| V | Lateral velocity |
| ω_{y} | Yaw rate of the vehicle |
| Ø_{y} | Heading direction of the vehicle relative to a y axis |
| | (i.e., running from front to rear) of the vehicle |
| e | Lateral offset (difference between vehicle's current |
| | position and desired position) |
| \dot{V} | Rate of change of lateral velocity, i.e., lateral |
| | acceleration |
| \dot{ω}_{y} | Rate of change of yaw rate |
| \dot{Ø}_{y} | Rate of change of heading direction |
| ė | Rate of change of lateral offset |
| U | Longitudinal velocity |

TABLE 2

| Operational | |
|---|---|
| Parameters | Explanation |
| C_{α}_{f} | Cornering stiffness of the front tire, e.g., in N/deg |
| | (Newton per degree) or N/rad (Newton per radian). |
| C_{α}ᵣ | Cornering stiffness of the rear tire, e.g., in N/deg |
| | (Newton per degree) or N/rad (Newton per radian). |
| a | Length of vehicle from a front bumper to the center of |
| | gravity |
| b | Length of vehicle from a rear rail to the center of gravity |
| J_{y} | Moment of inertia |
| m | Vehicle mass |
| δ | Vehicle steering angle |

The vehicle computer 110 can operate the vehicle 105 to travel along a path specified by a path polynomial by sending commands to actuators 120 and vehicle components 125 to control steering, brakes and powertrain of the vehicle 105 based on the current vehicle control settings that includes a longitudinal velocity U, a lateral velocity V, a yaw rate ω_{y}, a heading direction Ø_{y}, and a lateral offset e, and an output from the algorithm that includes the rate of change of lateral velocity \dot{V}, the rate of change of yaw rate \dot{ω}_{y}, the rate of change of heading direction \dot{Ø}_{y} and the rate of change of lateral offset ė.

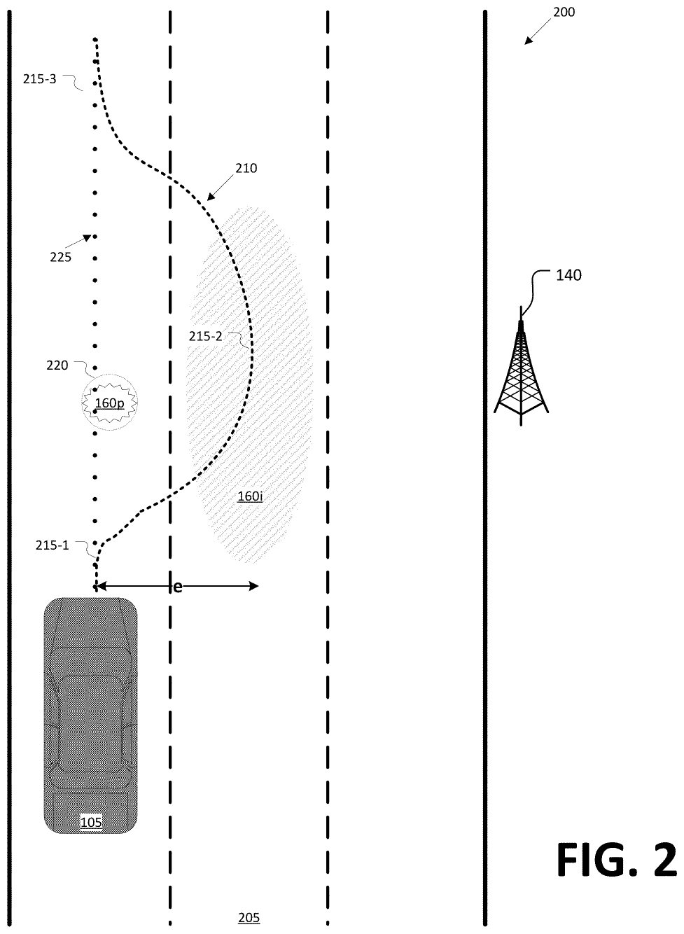

FIG. 2 illustrates an exemplary road scene 200, including the vehicle 105 traveling on a road 205. The road scene 200 includes two objects 160, a pothole 160p and an ice patch 160i. The vehicle 105 computer 110 can compute a path polynomial to follow a path 210, in this instance to avoid the pothole 160p and to account for reduced road friction in the ice patch 160i. The computer 110 thus uses the road condition map to modify a planned or nominal path 225, i.e., to follow the path 210, based on conditions indicated in the map. For example, to avoid the pothole 160p, specified in this example on a road condition map according to a circle 220 whose radius is defined so that the circle 220 encompasses all of the pothole 160p, the computer 110 determines a lateral offset e, i.e., a lateral distance on the road 210 between a current position of the vehicle 105 and a desired position of the vehicle 105, i.e., to avoid the pothole 160p. Further, in determining the path polynomial, the computer 110 can determine cornering stiffnesses, as defined above, for various points 215-1, 215-2, and 215-3 on the path 210. For example, road friction may be normal at the points 215-1 and 215-3, but reduced at the point 215-2, indicating modifications to velocity, heading, etc. at points such as the point 215-2 where cornering stiffness is reduced.

As an example regarding how conditions indicated in a road condition map can be used to modify vehicle 105 operation, here are examples of constraints on vehicle 105 settings that can be affected.

\dot{V}ₘᵢₙ(tₖ)≤\dot{V}(tₖ)≤\dot{V}ₘₐₓ(tₖ) (2)

\dot{ω}_{y,min}(tₖ)≤\dot{ω}_{y}(tₖ)≤\dot{ω}_{y,max}(tₖ) (3)

Ø_{y,min}(tₖ)≤Ø(tₖ)≤Ø_{y,max}(tₖ) (4)

eₘᵢₙ(tₖ)≤e(tₖ)≤eₘₐₓ(tₖ) (5)

Equation (2) expresses constraints for minimum and maximum rates of change for lateral velocity. These constraints can be affected by a change in cornering stiffness and/or a coefficient of friction. For example, when a vehicle 105 traverses an ice patch 160i, a permissible range of rates of change for lateral velocity may be decreased. Such constraints can be determined empirically, e.g., by test driving a vehicle 105 under known conditions to determine acceptable rates of change for lateral velocity, and then storing a table or the like in a vehicle 110 computer (where the vehicle 110 computer is in a vehicle 105 having a same or similar configuration to the test vehicle 105) for use in dynamically generating or modifying a path polynomial. Equation (3) operates similarly with respect to angular acceleration.

Equations (4) and 5) relate to vehicle heading and lateral offset, respectively, for example, a vehicle computer 110 could determine changes to vehicle heading and lateral offset to avoid a pothole 160p. These constraints could likewise be empirically developed, and stored in the computer 110. Constraints on heading and/or lateral offset could be modified based on a road condition map reporting an object 160 such as the pothole 160p. Other constraints could also be modified, e.g., if a pothole 160p was not so deep as to warrant driving around it, vehicle 105 speed constraints could be adjusted to slow the vehicle as it drove over or through the pothole 160p.

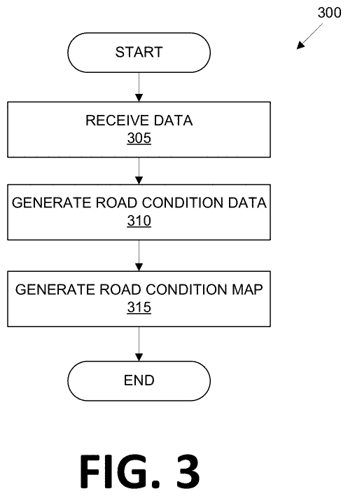

FIG. 3 is a flowchart of an exemplary process 300 for processing infrastructure node 140 sensor 165 data and sensor 115 data to generate a road condition map. The process 300, blocks of which can be executed in an order different than that described herein and/or can be executed in combination with other processing, and/or by omitting certain processing described herein, can be executed by programming in a node 140 computer 175.

The process 300 begins in a block 305, in which an infrastructure node 140 computer 175 receives sensor 165 data, e.g., image data and/or lidar data. The computer 175 could further receive map data, e.g., from a server 145, in the block 305, but also could receive the map data outside of the process 300, e.g., by periodic download from the remote server 145. Map data, in this context, means data specifying locations and/or areas of objects or features of objects such as node(s) 140, infrastructure objects 155, e.g., roads 155a, crosswalks 155b, overpasses, intersections, etc. Moreover, receipt of sensor 165 data in the computer 175 could be performed substantially continuously, or alternatively could be performed on a periodic basis, e.g., every five minutes, every hour, etc. Yet further, a message from the remote server 145 or some other device via the network 135 could trigger or instruct the computer 175 to obtain sensor 165 data. Yet further, the computer 175 could receive data from a vehicle 105 and/or one or more second vehicles 150a, e.g., vehicle 105 sensor 115 data or other data from a vehicle 105, e.g., data describing a speed, heading, etc. of the vehicle 105.

Next, the process 300 proceeds to a block 310. In the block 310, the computer 175 analyzes the received data to generate a set of identified objects 150, 160, e.g., as described above, and then determines whether any vehicles 105 are proximate to the node 140, which means that the vehicle(s) 105 is/are within a field of sensor(s) 145 and have been detected and included in the identified objects 150, 160. With respect to physical features 160, the computer 175 could be programmed to identify, if indicated in the sensor 165 data, a specified set of physical features 160, e.g., a slippery condition, a pothole, a speed bump, a road grade, a road bank, etc.

Next, in a block 315, the computer 175 generates the road condition map by specifying one or more identified objects or physical features 160, and possibly also objects 150, 155, along with each identified object's location or area, e.g., one or geo-coordinates relative to the map data. As mentioned above, the road condition map typically includes one or more sets of geographic points or areas, each specified according to one or more pairs of geo-coordinates, i.e., one pair of geo-coordinates specifies a point, two pairs of geo-coordinates specify a line, and three pairs of geo-coordinates specify an area. The computer 175 may transmit the road condition map to a vehicle computer 110 via a broadcast from the node 140, via vehicle-to-vehicle communications upon detecting the vehicle 101 proximate to the node 140, and/or in response to a message from the vehicle computer 110 requesting the road condition map from the computer 175.

Following the block 315, the process 300 ends.

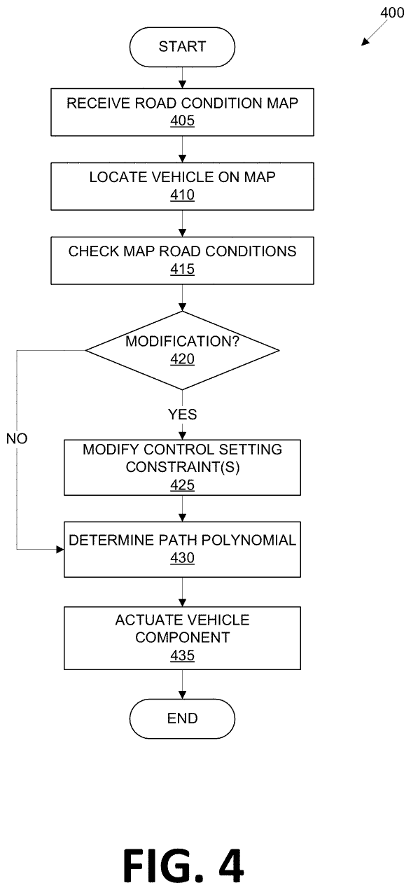

FIG. 4 is a flowchart of an exemplary process 400 for actuating a vehicle component based on a road condition map. The process 400, blocks of which can be executed in an order different than that described herein and/or can be executed in combination with other processing, and/or by omitting certain processing described herein, can be executed by programming in a vehicle computer 110.

The process 400 begins in a block 405, in which the vehicle computer 110 receives the road condition map from the computer 175, e.g., as discussed above regarding the process 300.

Next, in a block 410, the computer 110 locates the vehicle 105 on the received map. That is, the map typically specifies physical values describing physical features or objects 150, 155, 160 with respect to a coordinate system such as a geo-coordinate system, and the vehicle computer 110 typically receives data, e.g., GPS data or the like, to locate itself with respect to such coordinate system. Such physical values can be used, as described above and below, in determining a vehicle 105 path and/or maneuvers. In any event, in the block 410, the computer 110 can determine a location of the vehicle 105 on the received map, including a relative position of the vehicle 105 with respect to objects 150, 155, 160 specified on the map.

Next, in a block 415, the computer 110 identifies one or more road conditions, i.e., physical values respectively relating to one or more objects 160, e.g., as described above.

Next, in a decision block 420, the computer 110 determines whether any of the one or more physical values describing road conditions, i.e., physical features or objects 160, identified in the block 415 differ from operating parameters currently being used to determine the vehicle 105 path, e.g., the path polynomial. For example, if a vehicle 105 has not detected an object 160, e.g., has not stored a reduced coefficient of friction, etc., then the computer 110 could determine that mapped road conditions differ from road conditions identified by the vehicle 105, and therefore could determine to modify control settings or constraints as described above.

However, it is also possible that the computer 110 could be programmed to ignore physical values in the road condition map. For example, if sensor 115 data indicates a safety hazard, e.g., a pothole 160p where the road condition map indicates none, the computer 110 could be programmed to ignore the road condition map, at least for such data.

If the computer 110 determines to modify at least one control parameter or operational setting based on the road condition map, the process 400 proceeds to a block 425. Otherwise, the process 400 proceeds to a block 430.

In the block 425, the computer 110 modifies control settings and/or constraints on control settings as described above.

In a block 430, which may follow either of the blocks 420, 425, the vehicle computer 110 determines a path polynomial according to current operational parameters and control settings. For example, the vehicle computer 110 can determine or update a path polynomial based on vehicle operational parameters (such as tire corner coefficients, speed limits, etc.) and the vehicle control settings (such as longitudinal speed). Alternatively or additionally, the computer 110 could plan a maneuver based on physical values in a road condition map even if such maneuver did not substantially modify the vehicle 105 path. (For the avoidance of doubt, a “maneuver” as that term is used herein may or may not include a substantial modification of a vehicle 105 path.) To take one possible example from many, the computer 110 could receive data about a pothole 160p, were one specified physical value is a pothole diameter and depth that does not warrant altering a path to drive around the pothole 160p. However, the computer 110 could nonetheless perform a maneuver to modify vehicle 105 speed and/or steering, e.g., to slow the vehicle 105 and/or make a modification to a steering angle, to increase occupant comfort when driving over or through the pothole 160p.

Next, in a block 435, the computer 110 provides control commands to vehicle actuators according to the determined path polynomial. For example, the vehicle computer 110 can send commands to actuators 120 and vehicle components 125 to control steering, brakes and a powertrain of the vehicle 105 based on the vehicle control settings specified in the path polynomial such as a longitudinal velocity U, a lateral velocity V, a yaw rate ω_{y}, a heading direction Ø_{y}, a lateral offset e, a rate of change of lateral velocity \dot{V}, a rate of change of yaw rate \dot{ω}_{y}, a rate of change of heading direction \dot{Ø}_{y}, and a rate of change of lateral offset ė. Optimal control commands to actuators 120 and components 125 can be provided according to known techniques for solving a constrained optimization problem.

Following the block 435, the process 400 ends.

As used herein, the adverb “substantially” means that a shape, structure, measurement, quantity, time, etc. may deviate from an exact described geometry, distance, measurement, quantity, time, etc., because of imperfections in materials, machining, manufacturing, transmission of data, computational speed, etc. The word “substantial” should be similarly understood.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computers and computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

Memory may include a computer-readable medium (also referred to as a processor-readable medium) that includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of an ECU. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the media, processes, systems, methods, heuristics, etc. described herein, it should be understood that, although the steps of such processes, etc. have been described as occurring according to a certain ordered sequence, such processes may be practiced with the described steps performed in an order other than the order described herein. It further should be understood that certain steps may be performed simultaneously, that other steps may be added, or that certain steps described herein may be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A method, comprising:
receiving, in a vehicle, a map generated from infrastructure node sensor data specifying a location and a measurement of a physical value controlling vehicle operation at the location; and
determining a maneuver for the vehicle based in part on the physical value and the location.

2. The method of claim 1, wherein the physical value controlling vehicle operation is one of a tire corner coefficient, an acceleration, a steering angle, a maximum safe speed, and a stop distance.

3. The method of claim 1, further comprising operating the vehicle based on the maneuver.

4. The method of claim 1, wherein the maneuver includes a path polynomial, the method further comprising using the physical value as input to determine the path polynomial.

5. The method of claim 1, further comprising transmitting, from the vehicle, the physical value limiting vehicle operation to a second vehicle.

6. The method of claim 1, further comprising adjusting, in the vehicle computer, the physical value limiting vehicle operation.

7. The method of claim 1, wherein the map further specifies a second location and a second measurement of a physical value controlling vehicle operation at the second location.

8. The method of claim 1, wherein the map further specifies a measurement of a second physical value limiting vehicle operation at the location.

9. The method of claim 1, wherein the physical value describes one or more of a road bank, a road grade, a road friction, a pothole, a bump, and a debris object.

10. The method of claim 1, wherein the node sensor data includes one or more of LIDAR, RADAR, ultrasound, and camera image data.

11. A computer comprising a processor and a memory, the memory storing instructions executable by the processor to:
receive, in a vehicle, a map generated from infrastructure node sensor data specifying a location and a measurement of a physical value controlling vehicle operation at the location; and
determine a maneuver for the vehicle based in part on the physical value and the location.

12. The computer of claim 11, wherein the physical value controlling vehicle operation is one of a tire corner coefficient, an acceleration, a steering angle, a maximum safe speed, and a stop distance.

13. The computer of claim 11, further comprising instructions to operate the vehicle based on the maneuver.

14. The computer of claim 11, wherein the maneuver includes a path polynomial, the method further comprising using the physical value as input to determine the path polynomial.

15. The computer of claim 11, further comprising instructions to transmit, from the vehicle, the physical value limiting vehicle operation to a second vehicle.

16. The computer of claim 11, further comprising instructions to adjust, in the vehicle computer, the physical value limiting vehicle operation.

17. The computer of claim 11, wherein the map further specifies a second location and a second measurement of a physical value controlling vehicle operation at the second location.

18. The computer of claim 11, wherein the map further specifies a measurement of a second physical value limiting vehicle operation at the location.

19. The computer of claim 11, wherein the physical value describes one or more of a road bank, a road grade, a road friction, a pothole, a bump, and a debris object.

20. The computer of claim 11, wherein the node sensor data includes one or more of LIDAR, RADAR, ultrasound, and camera image data.
